(19) United States
(12) Patent Application Publication
(10) Pub. No.: US 2024/0274348 A1
(43) Pub. Date: Aug. 15, 2024

(54) CORE STRUCTURE AND COIL ASSEMBLY COMPRISING THE SAME

(71) Applicant: AMOGREENTECH CO., LTD., Gimpo-si, Gyeonggi-do (KR)

(72) Inventors: Seon Oh KIM, Gimpo-si, Gyeonggi-do (KR); Yoon Jae LEE, Gimpo-si, Gyeonggi-do (KR)

(21) Appl. No.: 18/563,201

(22) PCT Filed: May 24, 2022
(86) PCT No.: PCT/KR2022/007370

§ 371 Date: Nov. 21, 2023

(30) Foreign Application Priority Data
May 25, 2021 (KR) 10-2021-0066771

(51) Int. Cl. H01F 27/32; H01F 27/25; H01F 27/28

(52) U.S. Cl. CPC H01F 27/324; H01F 27/25; H01F 27/2823

(57) ABSTRACT

A core structure is provided. The core structure according to an embodiment of the present invention is a core structure on which a coil is wound, and comprises: a magnetic body which is formed to have a ring shape and is made of a magnetic material; a first guide which is formed to have a ring shape so as to come into contact with the inner circumferential surface of the magnetic body and is made of an insulative material; and an insulating layer with which the magnetic body and the first guide are at least partially coated so as to insulate the magnetic body.

### CROSS-REFERENCE TO RELATED APPLICATION

This application is the national phase entry of International Application No. PCT/KR2022/007370, filed on May 24, 2022, which is based upon and claims priority to Korean Patent Application No. 10-2021-0066771, filed on May 25, 2021, the disclosure of which is incorporated herein by reference in its entirety.

### TECHNICAL FIELD

The present invention relates to a core structure and a coil assembly including the same.

### BACKGROUND ART

Recently, in accordance with the development of small devices and an increase in demand thereof, the technologies for thinning electronic parts constituting electronic products are being actively developed.

For example, home appliances such as TV and the like have been developed in a wall mount method in order to minimize the degree of protrusion from the wall. Accordingly, the electronic components constituting a part of the TV have been continuously miniaturized and reduced in profile, and in particular, the demand for components having a thickness of 1 cm or less is increasing to meet the related standards.

In this regard, in the case of a coil part, since the method of winding a coil around a core is mainly used, the development of a low-profile core is required first in order to develop a thin coil part.

In this case, as the coil component is essentially required to secure withstand voltage between a core and a coil, in the case of the related art, a separate case member for sealing the core has been mainly used to secure withstand voltage characteristics required for safety.

However, since the case member for sealing the core has a thickness of approximately 1 mm or more, it has been pointed out as an impediment to thinning of electronic parts, such as exceeding 20% of the total thickness of coil parts.

Considering this situation, the situation is that it is necessary to develop a coil component which is capable of achieving a thinning of the electronic components and securing withstand voltage characteristics.

### SUMMARY OF THE INVENTION

The present invention has been devised in view of the above points, and an object of the present invention is to provide a core structure which is capable of thinning a coil part.

In addition, another object of the present invention is to provide a core structure which is capable of enhancing the withstand voltage characteristics of a coil part.

In order to achieve the above-described objects, the present invention provides a core structure, which is a core structure on which a coil is wound, including a magnetic body which is formed to have a ring shape and is made of a magnetic material; a first guide which is formed to have a ring shape so as to come into contact with the inner circumferential surface of the magnetic body and is made of an insulative material; and an insulating layer with which the magnetic body and the first guide are at least partially coated so as to insulate the magnetic body.

In addition, the magnetic body may be formed to have a first height, and the first guide may be formed to have a second height that is greater than or equal to the first height.

In this case, the first height and the second height may be the same.

In this case, the height at which the first guide protrudes from the magnetic body in the height direction may be smaller than the width direction thickness of the first guide.

In addition, the magnetic body may be completely covered by the first guide such that the inner circumferential surface is not exposed to the outside.

In addition, the core structure may further include a second guide which is formed to have a ring shape so as to come into contact the outer circumferential surface of the magnetic body, and is made of an insulative material, wherein the insulating layer may coat at least a part of the second guide.

In this case, the first guide and the second guide may be each formed to have a higher height than the magnetic body, and at least a part of the insulating layer may be disposed in a ring-shaped space formed between the first guide and the second guide.

In addition, the magnetic body may be formed by winding a plate-shaped amorphous ribbon sheet.

Meanwhile, the present invention provides a core structure, which is a core structure on which a coil is wound, including a magnetic body which is formed to have a ring shape and is made of a magnetic material: a second guide which is formed to have a ring shape so as to come into contact with the outer circumferential surface of the magnetic body and is made of an insulative material; and an insulating layer with which the magnetic body and the second guide are at least partially coated so as to insulate the magnetic body.

Moreover, the present invention provides a coil assembly, including the above-described core structure; and a coil which is wound on the core structure.

According to the present invention, it is possible to minimize the vertical height of a core structure by disposing an insulating layer instead of a case member on the top portion and bottom portion of a magnetic body.

As described above, the present invention can enhance the withstand voltage characteristics of a core structure by arranging guides inside and outside the magnetic body while achieving a thin core structure.

### BRIEF DESCRIPTION OF THE DRAWINGS

FIG. 1 is a view illustrating a coil assembly according to one embodiment of the present invention;

FIG. 2 is a view illustrating a core structure separated from the coil assembly of FIG. 1;

FIG. 3 is a cross-sectional view of FIG. 1;

FIG. 4 is a view illustrating a core structure included in a coil assembly according to another embodiment of the present invention;

FIG. 5 is a cross-sectional view of a coil assembly according to another embodiment of the present invention;

FIG. 6 is an explanatory diagram for explaining a case in which an insulating layer is formed without a guide;

FIG. 7 is an enlarged view of part A of FIG. 3; and

FIG. 8 is an enlarged view of a part corresponding to part A of FIG. 3 in FIG. 5.

### DETAILED DESCRIPTION OF THE INVENTION

Hereinafter, with reference to the accompanying drawings, the exemplary embodiments of the present invention will be described in detail so that a person skilled in the art can easily practice the present invention. The present invention may be embodied in many different forms and is not limited to the exemplary embodiments set forth herein. In order to clearly describe the present invention in the drawings, parts that are irrelevant to the description are omitted, and the same reference numerals are added to the same or similar components throughout the specification. In addition, the size or shape of the components shown in the drawings may be exaggerated for the clarity and convenience of description.

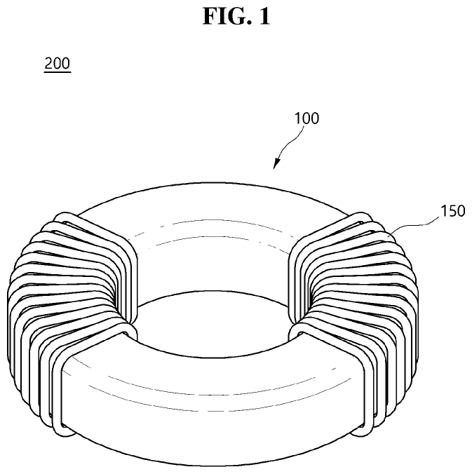

Referring to FIG. 1, the core structure 100 according to one embodiment of the present invention may be, for example, a structure which is formed to have a toroid or ring shape so as to support the winding of a coil, in a coil assembly 200 in which the coil is wound, such as a choke coil, a transformer, a motor or an inductor. Hereinafter, in the present specification, a ring shape is defined as including the toroid shape.

In this case, the core structure 100 according to one embodiment of the present invention may be thinned in overall size, while insulating a magnetic body 110 by coating the outer surface through an insulating layer 140. In addition, the core structure 100 according to one embodiment of the present invention has the advantage of strengthening the withstand voltage despite the introduction of the insulating layer 140 through guides 120, 130 that are disposed inside and outside the magnetic body 110.

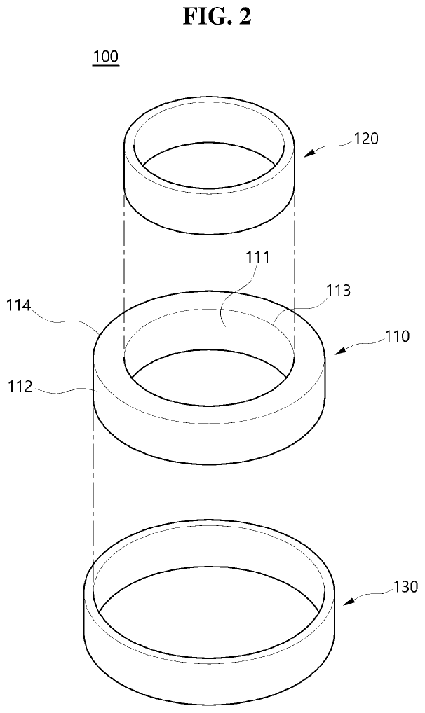

To this end, the core structure 100 according to one embodiment of the present invention may include a magnetic body 110, guides 120, 130 and an insulating layer 140, as illustrated in FIGS. 2 to 5.

In this case, with regard to the guides 120, 130, it is noted that the core structure 100 according to one embodiment of the present invention may include both of a first guide 120 and a second guide 130, or include only some of the same. This will be described in detail through the following description.

First of all, the magnetic body 110 may be formed of a magnetic material. Through this, the coil assembly 200 may remove noise or excite an induced current when it is applied to an EMI filter, for example, by having magnetic properties.

As a non-limiting example, the magnetic body 110 may be formed of at least one magnetic material selected from the group consisting of an amorphous alloy, an alloy including nanocrystalline grains, ferrite, a silicon steel plate, sand dust and permalloy.

In addition, the magnetic body 110 may be a powder magnetic core in the form of being molded into the desired shape, after mixing a powder obtained by ball milling a master alloy, which is formed from powder or a master alloy manufactured from a ribbon, with a binder, a core manufactured by winding an alloy manufactured in the form of a thin band or plate, or a laminated magnetic core manufactured by laminating alloys manufactured in the form of a thin band or plate.

Meanwhile, referring to FIG. 2, the magnetic body 110 may be formed in a ring shape having a hollow such that a coil may pass therethrough and be wound.

In this case, the ring-shaped magnetic body 110 may have an inner circumferential surface 111 and an outer circumferential surface 112 extending in the circumferential direction on the inside and outside, respectively.

In addition, the magnetic body 110 may include an inner corner portion 113 and an outer corner portion 114, which are portions where the inner circumferential surface 111 and the outer circumferential surface 112 are curved or bent, respectively, at the upper and lower direction ends of the inner circumferential surface 111 and the outer circumferential surface 112.

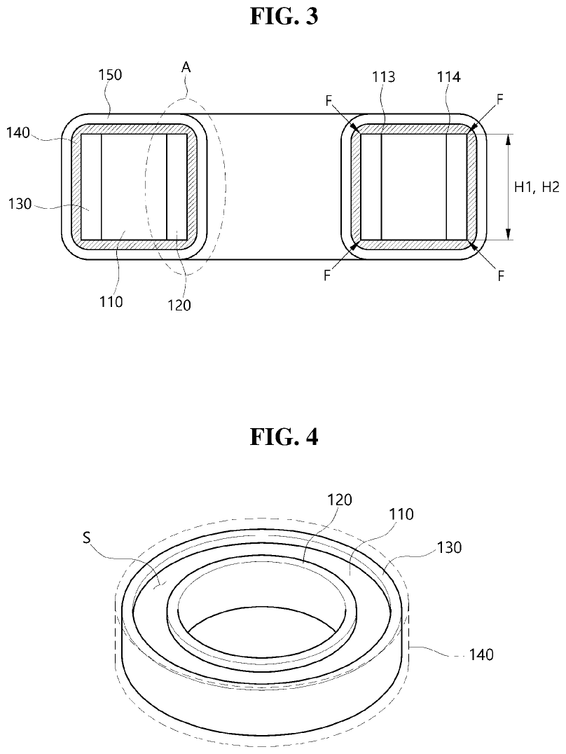

In this case, the inner corner portion 113 and the outer corner portion 114 may be bent while forming a predetermined angle (right angle in the case of FIG. 3), as illustrated in FIG. 3, respectively, and although not illustrated in the drawings, they may be formed in a curved surface having a predetermined curvature.

In particular, when the magnetic body 110 is formed by winding an amorphous alloy ribbon multiple times, sharply bent corner portions 113, 114 may be formed on the inside and outside of the ring-shaped magnetic material 110, respectively, as illustrated in FIG. 3, thereby weakening the withstand voltage of the coil assembly, and this will be described below through the explanations related to the guides 120, 130.

The core structure 100 according to one embodiment of the present invention may include a first guide 120 which is disposed inside the magnetic body 110 described above.

In one embodiment of the present invention, the first guide 120 may be formed of an insulative material to insulate the magnetic body 110 adjacent thereto from the outside. That is, the first guide 120 may perform a function of covering and insulating the magnetic body 110 together with the insulating layer 140 to be described below.

In this regard, as a non-limiting example, the first guide 120 may be formed of a mixture of an organic material and an inorganic material, or an organic material, and it may be formed of one or multiple types selected from a thermoplastic resin, a thermosetting resin and rubber. However, the material of the first guide 120 of the core structure 100 according to one embodiment of the present invention is not limited thereto, and any material may be applied as long as it has insulating properties.

In one embodiment of the present invention, the first guide 120 may be formed to have a ring shape to come into contact with the inner circumferential surface 111 of the magnetic body 110, as illustrated in FIGS. 2 and 3.

In this case, the first guide 120 may be formed to have a second height (H2) that is greater than or equal to a first height (H1) of the magnetic body 110. Through this, the first guide 120 may entirely cover the inner circumferential surface 111 of the magnetic body 110.

Specifically, as an example related to the height of the first guide 120, the first guide 120 may have the same height (H1=H2) as the magnetic body 110 as illustrated in FIG. 3. In this case, it is possible to minimize the vertical direction height of the core structure 100 by preventing the first guide 120 from protruding in the vertical direction from the magnetic body 110, and accordingly, it has the advantage of maximizing the thinning effect of the core structure 100.

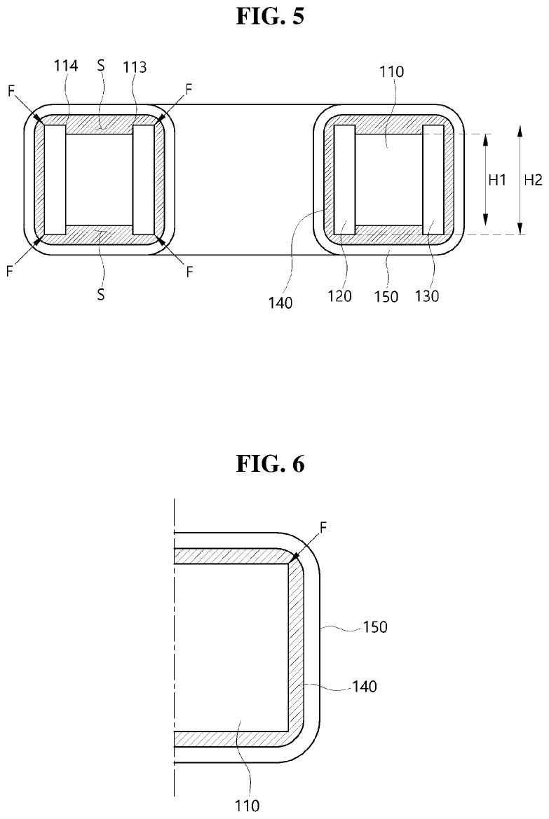

As another example related to the height of the first guide 120, the first guide 120 may have a height (H2) that is higher than the height (H1) of the magnetic body 110, as illustrated in FIGS. 4 and 5.

In this way, when the first guide 120 is formed to be higher than the magnetic body 110, the inner corner portion 113, which may be relatively vulnerable to external force, may be more stably protected. This will be described through a description related to the function of the first guide 120.

Meanwhile, when the magnetic body 110 has a bent inner corner portion 113 as illustrated in FIGS. 3 to 5 (e.g., when the magnetic body 110 is formed by winding an amorphous alloy ribbon multiple times), the first guide 120 is disposed in the form of being in close contact with the inner circumferential surface 111 of the magnetic body 110 such that the inner circumferential surface 111 is not exposed to the outside.

In one embodiment of the present invention, the thickness (L) of the first guide 120 in the horizontal direction may be thinner than the thickness of the magnetic body 110 and thicker than the thickness of the insulating layer 140 to be described below. For example, the first guide 120 may have a thickness of about 1 mm, but the present invention is not limited thereto, and it may be formed to be thicker or thinner than the same according to design.

Referring again to FIG. 2, the core structure 100 according to one embodiment of the present invention may include a second guide 130 which is disposed outside the magnetic body 110 in addition to the first guide 120 described above.

In this case, similar the first guide 120, the second guide 130 may be formed of an insulative material to insulate the magnetic body 110, and may be formed to have a ring shape to come into contact with the outer circumferential surface 112 of the magnetic body 110.

In addition, the second guide 130 may also be formed to have a second height (H2) that is greater than or equal to the first height (H1) of the magnetic body 110 as in the first guide 120, thereby completely covering the outer circumferential surface of the magnetic body 110.

In addition, the second guide 130 differs from the first guide 120 only in terms of the position where it is disposed, and generally has the same or similar structure and function as the first guide 12, and thus, the description thereof will be replaced with the description of the first guide 120.

Meanwhile, when the coil 150 is wound around the core structure 100, the first guide 120 and the second guide 130 may prevent a weakening of withstand voltages by concentrating stress on the corner portions 113, 114 of the coil assembly 200, and the related description thereof will be provided after the description of the insulating layer 140 is completed.

The core structure 100 according to one embodiment of the present invention may include an insulating layer 140 coating the magnetic body 110, the first guide 120 and the second guide 130.

In this case, the insulating layer 140 serves to insulate the magnetic body 110 together with the guides 120, 130, and it may be formed of an insulative material.

More specifically, as illustrated in FIG. 3, the insulating layer 140 may form a thin film on the outer surfaces of the magnetic body 110, the first guide 120 and the second guide 130 such that the magnetic body 110 can be blocked from being energized with the coil 150 side.

In this case, the insulating layer 140 is preferably formed of an insulative material having hardness or abrasion resistance that is sufficient to withstand an external force during the winding process of the coil 150.

As a non-limiting example related thereto, for the insulating layer 140, an insulating rubber material such as silicone rubber, fluororubber or butadiene rubber, or a well-known insulating resin material such as silicone-based, polyethylene-based, polypropylene-based, polyester-based, polyamide-based, fluororesin-based or polyacetal resin-based materials may be used.

As another example, the insulating layer 140 may include a liquid material such as enamel, varnish or epoxy, and in this case, it may be applied to the outer surface of the magnetic body 110, the first guide 120 or the second guide 130 by the spray coating method.

In one embodiment of the present invention, the thickness of the insulating layer 140 may be a numerical value that is smaller than the thicknesses of the first guide 120 and the second guide 130.

This is because instead of covering the upper and lower portions of the magnetic body 110 with a cover part (not illustrated) and a bottom part (not illustrated) that are formed of the same material as the guides 120, 130, respectively, the core structure 100 according to one embodiment of the present invention is intended to reduce the overall thickness of the core structure 100 by forming a relatively thin insulating layer 140. Through this, the core structure 100 according to one embodiment of the present invention may achieve the thinning of the coil assembly 200.

In this case, the insulating layer 140 may be formed within 0.2 mm as an illustrative example. However, the thickness of the insulating layer 140 is not limited thereto, and it may have a greater thickness than this, if necessary.

Meanwhile, as illustrated in FIGS. 3 and 5, the insulating layer 140 may be applied to entirely cover the outer surfaces of the first guide 120, the second guide 130 and the magnetic material 110 in a state in which the first guide 120 and the second guide 130 are disposed on the magnetic material 110, and then cured. Through this, the magnetic body 110 may maintain an electrically insulating state from the coil 150 that is wound on the outside of the insulating layer 140.

In particular, as illustrated in FIG. 5, when the first guide 120 and the second guide 130 are formed at heights that are higher than the magnetic body 110, the ring-shaped space (S) may be formed as described above, and in this case, the insulating layer 140 may be filled in the ring-shaped space (S).

In this regard, the insulating layer 140 may be filled only in the ring-shaped space (S) in order to minimize the vertical direction height of the core structure 100, or as illustrated in FIG. 5, in order to form a more stable insulating state, it may be arranged to entirely surround the first guide 120 and/or the second guide 130, including the ring-shaped space (S).

Hereinafter, the functions of the first guide 120 and the second guide 130 will be described in more detail with reference to the drawings.

As described above, when the coil is wound around the core structure 100, the first guide 120 and the second guide 130 may prevent stress from being concentrated on the corner portions 113, 114.

Specifically, as illustrated in FIG. 6, when the insulating layer 140 is formed with respect to the magnetic body 110 without the first guide 120 or the second guide 130, the insulating layer 140 may be formed relatively thin at the corner portions 113, 114, which are bent or curved portions due to the structural characteristics thereof.

Moreover, when the coil is wound on the outer surface of the core structure in which the corner portions 113, 114 are weak, the pulling force (F) during winding may be concentrated toward the corner portions 113, 114, which are bent or curved portions.

Therefore, when the coil assembly 200 is formed by using the core structure without the guides 120, 130, as the stress is concentrated on the corner portions 113, 114 that are already weak due to the relatively thin formation, there is a high possibility that the insulating layer 140 covering the corners 113, 114 is easily worn or peeled off. As a result, the withstand voltage characteristics of the coil assembly 200 may be greatly weakened.

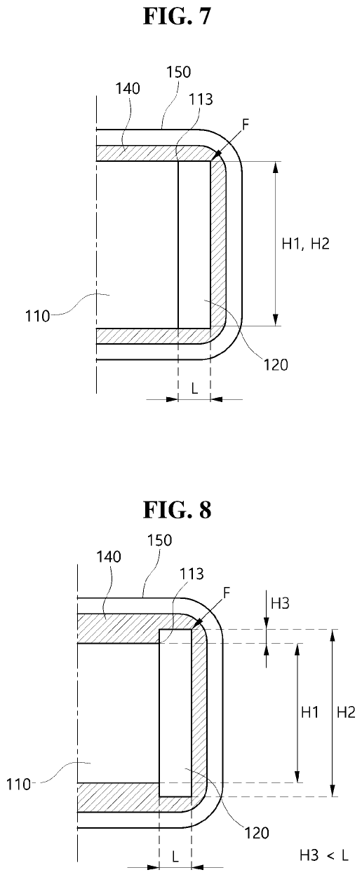

Unlike this, when the first guide 120 or the second guide 130 is provided as in the core structure 100 according to one embodiment of the present invention, as illustrated in FIGS. 7 and 8, since the guides 120, 130 protect the corner portions of the core structure 100, the insulating layer 140 having a sufficient thickness may be formed in areas that are adjacent to the corner portions 113, 114 of the magnetic material 110.

Moreover, in the case of the core structure 100 according to one embodiment of the present invention, the stress (F) generated when winding the coil 150 is concentrated on the corner parts of the guides 120, 130 instead of the corner portions 113, 114 of the magnetic body 110, and thus, it is possible to solve the problem of peeling of the insulating layer 140 formed on the corner portions 113, 114 of the magnetic body 110 as described above.

Even if stress is concentrated on the corner part of the first guide 120 and the insulating layer 140 in the adjacent area is peeled off, in this case, instead of exposing the magnetic body 110, since the first guide 120 having insulating properties is exposed, it is possible to prevent a phenomenon in which the withstand voltage characteristics of the coil assembly 200 are weakened.

Compared to the case where the magnetic material 110 may include curved corner portions 113, 114, such as a ferrite magnetic material, the protection effect of the magnetic material 110 by the guides 120, 130 may be more effective in a magnetic material formed by winding an amorphous alloy ribbon multiple times.

This is because, in the case of a winding core which is wound with an amorphous alloy ribbon, it is inevitable to include sharply bent corner portions 113, 114 due to structural characteristics. That is, in this case, if the guides 120, 130 are absent, the insulating layer 140 has no choice but to be formed in a very thin shape with respect to the corner portions 113, 114, and the stress concentration phenomenon may be more remarkable.

Meanwhile, in one embodiment of the present invention, as illustrated in FIG. 8, when the height (H2) of the first guide 120 is formed to be higher than the height (H1) of the magnetic body 110, the withstand voltage characteristics of the coil assembly 200 may be further strengthened. In this case, as illustrated in the drawings, since the first guide 120 functions as one wall, the corners 113, 114 of the magnetic body 110 may be completely protected.

Moreover, in this case, since a thicker insulating layer 140 may be formed in the upper or lower areas of the magnetic body 110 due to the height (H3) of which the first guide 120 protrudes from the magnetic body 110, it is possible to further strengthen the withstand voltage characteristics.

In this case, as described above, when the insulating layer 140 is disposed only for the ring-shaped space (S) formed above or below the magnetic body 110 for thinning the core structure 100, it has the advantages of being able to protect the corner portions 113, 114 of the magnetic body 110 thickly, while being able to reduce the thickness of the core assembly 100 in the height direction.

In the above description, the core structure 100 according to one embodiment of the present invention has been described as an example that is formed by including both of the first guide 120 and the second guide 130, but the present invention is not limited thereto.

That is, the core structure 100 according to one embodiment of the present invention may protect the magnetic body 110 by providing only any one of the first guide 120 and the second guide 130 as necessary.

As an illustrative example, according to the winding direction of the coil 150, stress may be more concentrated on any one of the outer corner portion 114 or the inner corner portion 113. In this case, instead of arranging the guides 120, 130 on both of the inner and outer sides, the process may be simplified and materials may be saved by arranging the guides only on one side that the insulating layer 140 is likely to be peeled off. However, in order to protect the magnetic body 110 even more, it would be preferable to arrange the guides 120, 130 on both of the inner and outer sides.

As described above, the core structure 100 according to one embodiment of the present invention has a thin insulating layer formed on the top portion and bottom portion of the magnetic material 110 instead of a case member in the shape of a box that surrounds the top, bottom, left and right directions of the magnetic material 110, thereby minimizing the height of the core structure. In this case, the core structure according to one embodiment of the present invention may achieve both of thinning and improved durability by supplementing some weak parts that may occur when insulating the magnetic material 110 with only the insulating layer 140 by arranging unique guides 120, 130.

Although one embodiment of the present invention has been described above, the spirit of the present invention is not limited to the embodiments presented herein, and those skilled in the art who understand the spirit of the present invention may easily suggest other embodiments by changing, modifying, deleting or adding components within the scope of the same spirit, but this will also fall within the scope of the present invention.

1. A core structure, which is a core structure on which a coil is wound, comprising:
a magnetic body which is formed to have a ring shape and is made of a magnetic material;
a first guide which is formed to have a ring shape so as to come into contact with the inner circumferential surface of the magnetic body and is made of an insulative material; and
an insulating layer with which the magnetic body and the first guide are at least partially coated so as to insulate the magnetic body.

2. The core structure of claim 1, wherein the magnetic body is formed to have a first height, and the first guide is formed to have a second height that is greater than or equal to the first height.

3. The core structure of claim 2, wherein the first height and the second height are the same.

4. The core structure of claim 2, wherein the height at which the first guide protrudes from the magnetic body in the height direction is smaller than the width direction thickness of the first guide.

5. The core structure of claim 1, wherein the magnetic body is completely covered by the first guide such that the inner circumferential surface is not exposed to the outside.

6. The core structure of claim 1, further comprising:
a second guide which is formed to have a ring shape so as to come into contact the outer circumferential surface of the magnetic body, and is made of an insulative material,
wherein the insulating layer coats at least a part of the second guide.

7. The core structure of claim 6, wherein the first guide and the second guide are each formed to have a higher height than the magnetic body, and
wherein at least a part of the insulating layer is disposed in a ring-shaped space formed between the first guide and the second guide.

8. The core structure of claim 1, wherein the magnetic body is formed by winding a plate-shaped amorphous ribbon sheet.

9. A core structure, which is a core structure on which a coil is wound, comprising:
a magnetic body which is formed to have a ring shape and is made of a magnetic material;
a second guide which is formed to have a ring shape so as to come into contact with the outer circumferential surface of the magnetic body and is made of an insulative material; and
an insulating layer with which the magnetic body and the second guide are at least partially coated so as to insulate the magnetic body.

10. A coil assembly, comprising:
the core structure of claim 1; and a coil which is wound on the core structure.

11. A coil assembly, comprising:
the core structure of claim 9; and a coil which is wound on the core structure.
